(19) United States
(12) Patent Application Publication
(10) Pub. No.: US 2013/0328534 A1
(43) Pub. Date: Dec. 12, 2013

(54) METHOD OF CONTROLLING A POWER CONVERTING DEVICE AND RELATED CIRCUIT

(71) Applicant: NOVATEK MICROELECTRONICS CORP., Hsin-Chu (TW)

(72) Inventor: Chun-Yu Hsieh, Taichung City (TW)

(73) Assignee: NOVATEK MICROELECTRONICS CORP., Hsin-Chu (TW)

(21) Appl. No.: 13/742,370

(22) Filed: Jan. 16, 2013

(30) Foreign Application Priority Data
Jun. 8, 2012 (TW) 101120668

(51) Int. Cl. G05F 3/02

(52) U.S. Cl. CPC G05F 3/02
USPC 323/271

(57) ABSTRACT

A method of controlling a power converting device which includes an inductor, a first switch coupled between an input end and a first node of the inductor, a second switch coupled between a second node of the inductor and ground, a third switch coupled between the first node of the inductor and ground and a fourth switch coupled between the second node of the inductor and an output end includes generating a pulse width modulation signal according to an output voltage of the output end, a switch current of the first switch and a ramp voltage; and controlling the first switch, the second switch, the third switch and the fourth switch according to the pulse width modulation signal and a clock signal.

### BACKGROUND OF THE INVENTION

1. Field of the Invention

The present invention relates to a method and related circuit for controlling a power converting device, and more particularly, to a method and related circuit capable of utilizing a peak current mode for controlling a power converting device.

2. Description of the Prior Art

A DC/DC converter is the common voltage converter utilized in modern electronic devices. It is utilized for converting a DC input voltage (e.g. voltages provided by a battery) to a DC output voltage of different voltage levels. Various types of the DC/DC converter can be classified into boost, buck, and buck-boost. Since the voltage provided by the battery will not be at a constant voltage level, an electronic device which adapts the buck-boost DC/DC converter could effectively prolong the battery life of the electronic device.

Please refer to FIG. 1, which is a schematic diagram of a conventional buck-boost DC/DC converter 10. As shown in FIG. 1, the buck-boost DC/DC converter 10 comprises an inductor L and switches SA-SD. The buck-boost DC/DC converter 10 converts an input voltage VIN of an input end IN to an output voltage VOUT via controlling conducting sequences of the switches SA-SD according to control signals CONA-COND, and then outputs the output voltage VOUT to an output end OUT for providing an output current IOUT to the output end OUT. In detail, a clock period of the buck-boost converter 10 is divided into a charging period and a discharging period. In the charging period, the buck-boost DC/DC converter 10 conducts the switches SA, SB and disconnects the switches SC, SD via adjusting the control signals CONA-COND, resulting in the input voltage VIN starting to charge the inductor L. When the energy stored in the inductor L is sufficient, the buck-boost DC/DC converter 10 disconnects the switches SA, SB and conducts the switches SC, SD via adjusting the control signals CONA-COND, such that the energy stored in the inductor L is distributed to the output end OUT for maintaining the output voltage VOUT at a constant voltage. Via adjusting the time ratio between the charging period and the discharging period in the clock period, the buck-boost DC/DC converter 10 alternately operates in a boost mode and a buck mode. Assuming the time ratio of the charging period is a ratio D and the time ratio of the discharging period is a ratio (1-D), the buck-boost DC/DC converter 10 operates in the buck mode when the ratio D is between 0.5 and 0 (i.e. 0.5≧D≧0); and the buck-boost DC/DC converter 10 operates in the boost mode when the ratio D is between 1 and 0.5 (i.e. 1≧D≧0.5). Voltages VL1, VL2 across the inductor L can be expressed as:

$$\frac{VL 2}{VL 1} = \frac{D}{1 - D} \qquad ( 1 )$$

The output current IOUT and the inductor current IL can be expressed as:

$$IL = \frac{IOUT}{1 - D} \qquad ( 2 )$$

When the buck-boost DC/DC converter 10 enters steady state, the averages of voltages across the inductor L will be the same (i.e. VL1=VL2). As can be seen from (1) and (2), the inductor current IL will be twice the output current IOUT, resulting in greater conducting loss in the buck-boost DC/DC converter 10. In comparison, if the buck-boost DC/DC converter 10 conducts the switches SA, SD and disconnects the switches SB, SC such that the inductor current IL equals the output current IOUT (i.e. the input voltage VIN directly provides energy to the output end OUT), the conducting loss of the buck-boost DC/DC converter 10 is effectively reduced.

Therefore, if the switch SB is continuously disconnected, the switch SC is continuously conductive and the switches SA, SD are alternately conductive when the buck-boost DC/DC converter 10 operates in the buck mode, the inductor current IL will be reduced and the conducting loss of the buck-boost DC/DC converter 10 will decrease. Similarly, if the switch SA is continuously conductive, the switch SC is continuously disconnected and the switches SB, SD are alternately conductive when the buck-boost DC/DC converter 10 operates in the boost mode, the inductor current IL will also be reduced and the conducting loss of the buck-boost DC/DC converter 10 decreases. In other words, prolonging the time that switches SA, SD are simultaneously conductive can effectively decrease the average power consumption of the buck-boost DC/DC converter 10.

In addition, while prolonging the time that switches SA, SD are simultaneously conductive, the times of switching the switches is also decreased (only switching the switches SA, SC or the switches SB, SD), such that the switching loss of the buck-boost DC/DC converter 10 is effectively reduced and the gate charge/discharge of the gates of switches SA-SD is also decreased. Thus, the conversion efficiency of the buck-boost DC/DC converter 10 is accordingly increased.

As can be seen from the above, how to maximize the time of the switches SA, SD being simultaneously conductive and how to minimize the times of switching the switches SA-SD for minimizing the conducting loss and the switching loss of the buck-boost DC/DC converter is a desired goal in the industry.

### SUMMARY OF THE INVENTION

The present invention provides a method and related circuit utilizing the peak current mode for controlling the power converting device, to reduce the average power consumption of the power converting device.

The present invention discloses a method of controlling a power converting device which comprises an inductor, a first switch coupled between an input end and a first node of the inductor, a second switch coupled between a second node of the inductor and ground, a third switch coupled between the first node of the inductor and ground and a fourth switch coupled between the second node of the inductor and an output end. The method comprises generating a pulse width modulation signal according to an output voltage of the output end, a switch current of the first switch and a ramp voltage; and controlling the first switch, the second switch, the third switch and the fourth switch according to the pulse width modulation signal and a clock signal.

The present invention further discloses a feedback control circuit for a power converting device which comprises an inductor, a first switch, a second switch, a third switch and a fourth switch, comprising a pulse width modulation module. The feedback control circuit comprises a voltage dividing unit coupled to an output end of the power converting device for outputting a feedback voltage according to an output voltage of the power converting device; an error amplifier, coupled to the voltage dividing unit for generating an error voltage according to the feedback voltage and a first reference voltage; a current detecting unit, for detecting a switch current of the first switch; a slope compensation unit, for generating a ramp voltage according to a slope compensation control signal; an adding unit, coupled to the current detecting unit and the slope compensation unit for generating a second reference voltage according to the switch current and the ramp voltage; and a comparing unit, coupled to the error amplifier and the adding unit for generating a pulse width modulation signal according to the error voltage and the second reference voltage signal; a clock generating module, for generating a clock signal; and a logic control module, for generating a first control signal, a second control signal, a third control signal, a fourth control signal and the slope compensation control signal according to the clock signal and the pulse width modulation signal, to separately control the first switch, the second switch, the third switch and the fourth switch.

The present further discloses a power converting device. The power converting device comprises an inductor; a first switch, coupled between an input end and a first end of the inductor for controlling the connection between the input end and the first end according to a first control signal; a second switch, coupled between a second end of the inductor and ground for controlling the connection between the second end and ground according to a second control signal; a third switch, coupled between the first end of the inductor and ground for controlling the connection between the first end and ground according to a third control signal; a fourth switch, coupled between the second end of the inductor and an output end for controlling the connection between the second end and the output end according to a fourth control signal; and a feedback control circuit, for outputting the first control signal, the second control signal, the third control signal and the fourth control signal according to an output voltage of the output end and a switch current of the first switch, to control conducting sequences of the first switch, the second switch, the third switch and the fourth switch.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional buck-boost DC/DC converter.

FIG. 2 is a schematic diagram of a power converting device according to an embodiment of the present invention.

FIG. 3A is a schematic diagram of related signals when the power converting circuit shown in FIG. 2 operates in the buck mode.

FIG. 3B is a schematic diagram of related signals when the power converting device shown in FIG. 2 operates and the input voltage is slightly greater than the output voltage.

FIG. 3C is a schematic diagram of related signals when the power converting device shown in FIG. 2 operates and the input voltage is slightly smaller than the output voltage.

FIG. 3D is a schematic diagram of related signals when the power converting circuit shown in FIG. 2 operates in the boost mode.

FIG. 4A is a schematic diagram of a realization method of the current detecting unit shown in FIG. 2.

FIG. 4B is a schematic diagram of a realization method of the logic control module shown in FIG. 2.

FIG. 5 is a schematic diagram of state machine executed by the control signal generating unit shown in FIG. 4B.

FIG. 6 is a schematic diagram of a power converting device according to another embodiment of the present invention.

FIG. 7A is a schematic diagram of a power converting device according to another embodiment of the present invention.

FIG. 7B is a schematic diagram of a current sensing unit of the power converting device shown in FIG. 7A.

FIG. 8 is a schematic diagram of another implementation method of the control signal generating unit shown in FIG. 4B.

FIG. 9A is a schematic diagram of the method according to an embodiment of the present invention.

FIG. 9B a schematic diagram of an implementation method of the method shown in FIG. 9A.

### DETAILED DESCRIPTION

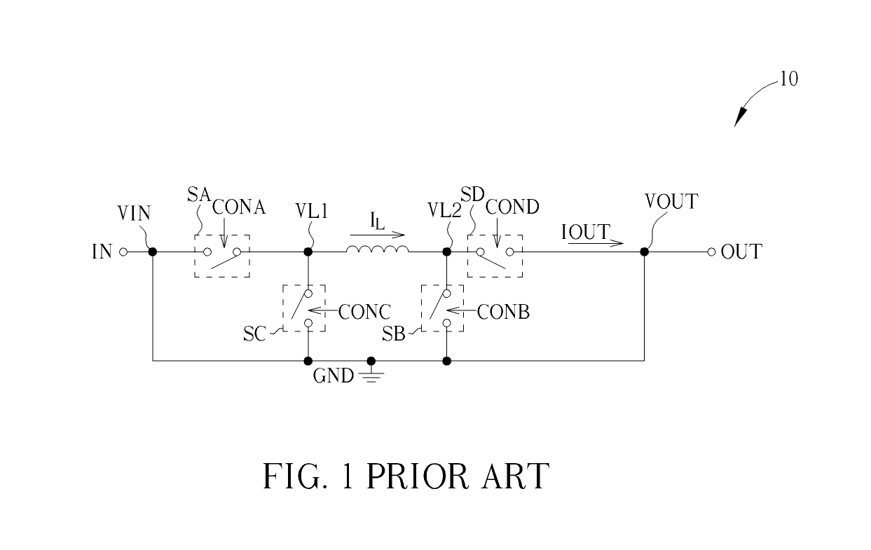

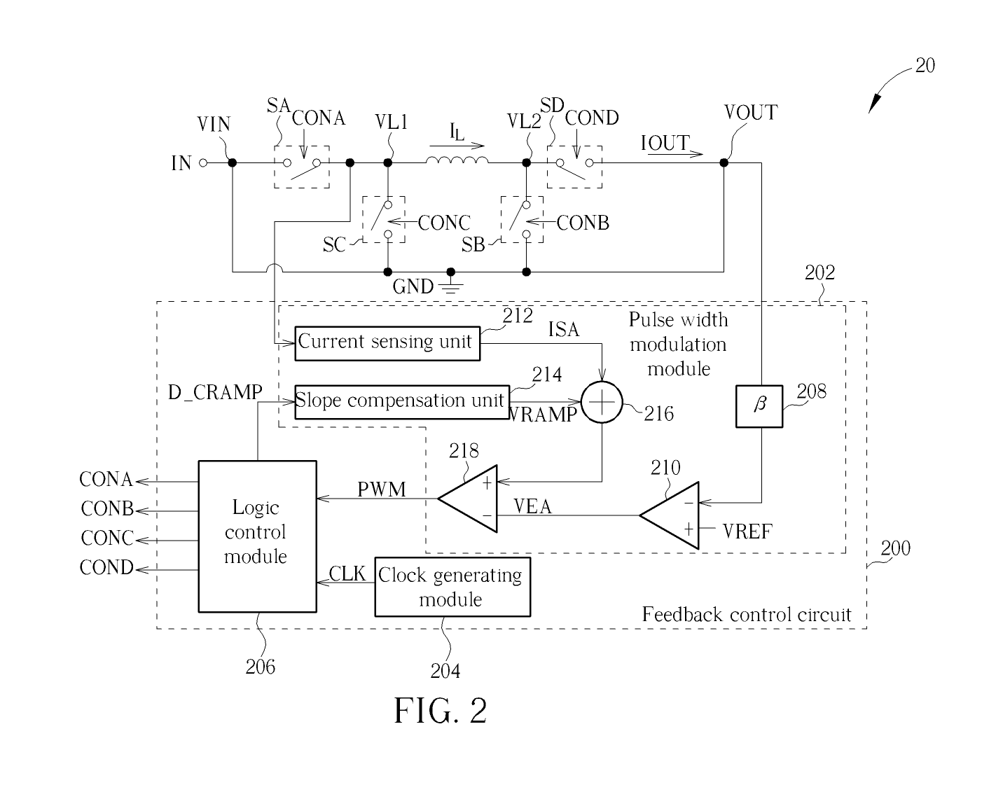

Please refer to FIG. 2, which is a schematic diagram of a power converting device 20 according to an embodiment of the present invention. The power converting device 20 is utilized for converting an input voltage VIN to an output voltage VOUT and maintaining the output voltage VOUT at a constant voltage. As shown in FIG. 2, the power converting device 20 comprises an inductor L, switches SA-SD and a feedback control circuit 200. The operating methods of the inductor L and switches SA-SD are similar to those shown in FIG. 1, thus the same symbols are used. The feedback control circuit 200 comprises a pulse width modulation module 202, a clock generating module 204 and a logic control module 206. The feedback control circuit 200 is utilized for controlling the conducting sequences of the switches SA-SD through the control signals CONA-COND according to a switch current of the switch SA and the output voltage VOUT. Via the feedback control circuit 200, the power converting device 20 prolongs the time that the switch SA and the switch SD are simultaneously conductive while operating. The conducting loss of the power converting device 20 is decreased. In addition, the feedback control circuit 200 also minimizes the times of switching the switches SA-SD, thus the switching loss of the power converting device 20 is decreased. In other words, the feedback control circuit 200 effectively decreases the conducting loss and the switching loss of the power converting device 20 and increases the conversion efficiency of the power converting device 20.

Specifically, the pulse width modulation module 202 comprises a voltage dividing unit 208, an error amplifier 210, a current detecting unit 212, a slope compensation unit 214, an adding unit 216 and a comparing unit 218. The voltage dividing unit 208 is coupled to the output end OUT for generating a feedback voltage VFB according to the output voltage VOUT. The feedback voltage VFB is proportional to the output voltage VOUT. The error amplifier 210 is coupled to the voltage dividing unit 208 for generating an error voltage VEA according to the feedback voltage VFB and a reference voltage VREF1. The current detecting unit 212 is utilized for detecting the switch current of the switch SA, to generate a current signal ISA. The slope compensation unit 214 is utilized for generating a ramp voltage VRAMP according to a slope compensation control signal D_CRAMP, to avoid the output voltage VOUT from being unstable. The adding unit 216 is coupled to the current detecting unit 212 and the slope compensation unit 214, for generating a reference voltage VREF2 according to the current signal ISA and the ramp voltage VRAMP. The comparing unit 218 is utilized for generating a pulse width modulation signal PWM according to the error voltage VEA and the reference voltage VREF2. As a result, the pulse width modulation module 202 instructs whether the reference voltage VREF2 exceeds the error voltage VEA (i.e. whether the inductor L stores sufficient energy for providing the output end OUT) through the pulse width modulation signal PWM.

The clock generating module 204 is utilized for generating a clock signal CLK for instructing the beginning of each clock period. The clock generating module may be realized by a clock generator such as a phase locked loop (PLL) clock generator, a delay locked loop (DLL) clock generator and a crystal oscillator, but is not limited herein. The logic control module 206 is utilized for generating the control signals CONA-COND and the slope compensation control signal D_CRAMP, to instruct the power converting device 20 to enter the charging period via adjusting the control signals CONA-COND and the slope compensation control signal D_CRAMP when the clock signal CLK instructs a clock period to start. The logic control module 206 further instructs the power converting device 20 to end the charging period through adjusting the control signals CONA-COND and the slope compensation control signal D_CRAMP when the pulse width modulation signal PWM instructs the reference voltage VREF2 to exceed the error voltage VEA. As a result, the feedback control circuit 200 prolongs the time that the switch SA and the switch SD are simultaneously conductive and minimizes the switching times of the switches SA-SD via detecting the switch current of the switch SA and the output voltage VOUT.

In detail, when the power converting device 20 starts to operate, the logic control module 206 presets the control signals CONA-COND when a clock period CLK_1 begins, for conducting the switches SA, SD and disconnecting the switches SB, SC. Then, the logic control module 206 controls the power converting device 20 to operate in a buck mode, a buck-boost mode or a boost mode through adjusting the control signals CONA-COND and the slope compensation control signal D_CRAMP according to the relationship between the input voltage VIN and the output voltage VOUT.

If the input voltage VIN is greater than the output voltage VOUT at the beginning of the clock period CLK_1, the input voltage VIN not only provides energy to the output end OUT but also rapidly stores energy in the inductor L, resulting in the inductor current IL (i.e. the switch current of the switch SA) quickly increasing such that the reference voltage VREF2 (proportional to the sum of the switch current of the switch SA and the ramp voltage VRAMP) is quickly increased. Thus, the reference voltage VREF2 will exceed the error voltage VEA within the clock period CLK_1. While receiving the pulse width modulation signal PWM instructing the reference voltage VREF2 to exceed the error voltage VEA, the logic control module 206 conducts the switches SC, SD and disconnects the switches SA, SB via adjusting the control signals CONA-COND. The inductor L starts to distribute the stored energy to the output end OUT. Next, when the clock signal CLK instructs a next clock period CLK_2 to begin, the logic control module 206 conducts the switches SA, SD and disconnects the switch SB, SC (i.e. the power converting device 20 goes back to the default status) for stopping the inductor L distributing energy to the output end OUT. Through repeating the above operations, the logic control module 206 continuously conducts the switch SD and alternately conducts the switch SA and the switch SC, such that the power converting device 20 operates in the buck mode. Accordingly, when operating in the buck mode, the switching loss of the power converting device 20 is effectively decreased.

If the input voltage VIN is slightly greater than the output voltage VOUT when the clock period CLK_1 begins, the input voltage VIN can provide the energy to the output end but cannot rapidly store energy in the inductor L. Thus, the inductor current IL is slowly increased, and the reference voltage VREF2 will not exceed the error voltage VEA in the clock period CLK_1. When the clock signal CLK instructs the next clock period CLK_2 to begin, the logic control module 206 conducts the switches SA, SB and disconnects the switch SC, SD via adjusting the control signals CONA-COND. The voltage difference across the inductor L is enlarged and the inductor current IL is rapidly increased. In such a condition, the reference voltage VREF2 will exceed the error voltage VEA within the clock period CLK_2. When the pulse width modulation signal PWM instructs the reference voltage VREF2 to exceed the error voltage VEA, the logic control module 206 conducts the switches SA, SD and disconnects the switches SB, SC via adjusting the control signals CONA-COND, such that the input voltage VIN directly provides energy to the output end OUT. Since the input voltage VIN is slightly greater than the output voltage VOUT, the reference voltage VREF2 will exceed the error voltage VEA within the clock period CLK_2 again. When the pulse width modulation signal PWM instructs the reference voltage VREF2 to exceed the error voltage VEA again, the logic control module 206 conducts the switches SC, SD and disconnects the switches SA, SB via adjusting the control signal CONA-COND. The inductor L starts to distribute the stored energy to the output end OUT. Finally, when the clock signal CLK instructs a next clock period CLK_3 to begin, the logic control module 206 conducts the switches SA, SD and disconnects the switch SB, SC via adjusting the control signals CONA-COND for stopping the inductor L releasing the energy to the output end OUT (i.e. the power converting device 20 goes back to the default status). As a result, via repeating the above operations, the power converting device 20 will operate in the buck-boost mode. Please note that the logic control module 206 effectively prolongs the time that the switch SA and the switch SD are simultaneously conductive when the power converting device 20 operates in the buck-boost mode. The conducting loss of the power converting device 20 is decreased and the conversion efficiency of the power converting device 20 is increased. Via prolonging the time that the switches SA, SD are simultaneously conductive, the switching operations of the power converting device 20 will be smoother. Thus, the ripples of the output voltage VOUT are lessened.

If the input voltage VIN is slightly smaller than the output voltage VOUT when the clock period CLK_1 begins, the operation procedures of the logic control module 206 will be similar to those when the input voltage VIN is slightly greater than the output voltage VOUT. Compared with the operating procedures when the input voltage VIN is slightly greater than the output voltage VOUT, the inductor current IL is slowly decreased when the switches SA, SD are conductive and the switches SB, SC are disconnected, causing the input voltage to be slightly smaller than the output voltage VOUT. In such a condition, both times the pulse width modulation signal PWM instructs the reference voltage VREF2 to exceed the error voltage VEA within the clock period CLK2 are both postponed. In brief, the logic control module 206 still effectively prolongs the time that the switches SA, SD are simultaneously conductive. The conducting loss of the power converting device 20 is decreased and the conversion efficiency of the power converting device 20 is increased. The switching operations of the power converting device 20 become smoother and the ripples of the output voltage VOUT are lessened due to the simultaneous conduction of the switches SA, SD.

If the input voltage VIN is smaller than the output voltage VOUT when the clock period CLK_1 begins, the input voltage VIN cannot store energy in the inductor L and the energy of the output end OUT is provided by the inductor L, resulting in the inductor current IL being rapidly decreased. When the clock signal CLK instructs the next clock period CLK_2 to begin, the logic control module 206 conducts the switches SA, SB and disconnects the switches SC, SD via adjusting the control signals CONA-COND. The voltage difference across the inductor L is enlarged and the inductor current IL is quickly increased. In such a condition, the reference voltage VREF2 will exceed the error voltage VEA in the clock period CLK_2. When the pulse width modulation signal PWM instructs the reference voltage VREF2 to exceed the error voltage VEA, the logic control module 206 conducts the switches SA, SD and disconnects the switches SB, SC via adjusting the control signals CONA-COND. The inductor L begins to distribute energy to the output end OUT. Since the input voltage VIN is smaller than the output voltage VOUT, the inductor current IL is rapidly decreased. The reference voltage VREF2 will not exceed the error voltage VEA within the clock period CLK_2 again. When the clock signal CLK instructs the next clock period CLK_3 to begin, the logic control module 206 conducts the switches SA, SB and disconnects the switches SC, SD via adjusting the control signals CONA-COND. The operations in the clock period CLK_2 will repeatedly occur and the power converting device 20 will operate in the boost mode. Please note that the logic control module 206 instructs the power converting device 20 to operate in the boost mode via continuously conducting the switch SA and alternately conducting the switch SB and the switch SD. Thus, the switching loss of the power converting device 20 is effectively decreased.

As can be seen from the above, the feedback control circuit 200 can generate appropriate control signals CONA-COND via detecting the switch current of the switch SA and the output voltage VOUT for controlling the conducting sequences of the switches SA-SD. The time that the switches SA, SD are simultaneously conductive is maximized and the switching times of the switches SA-SD is minimized.

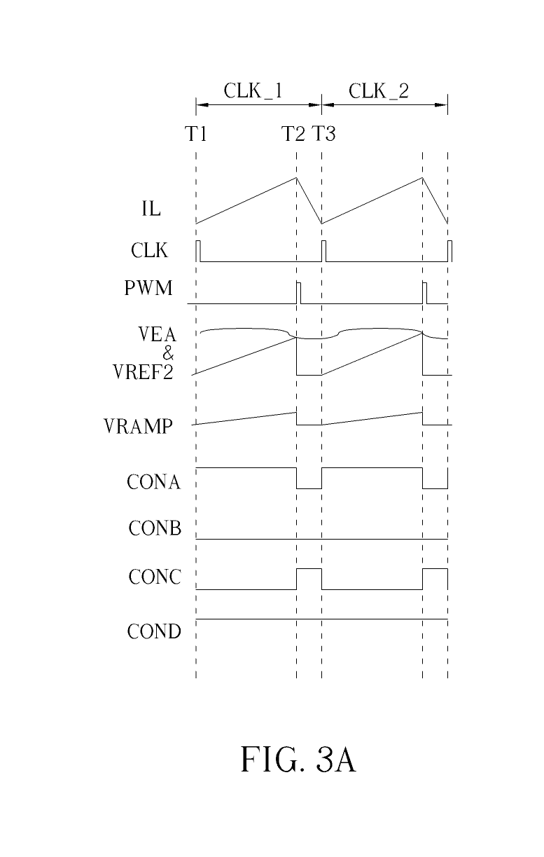

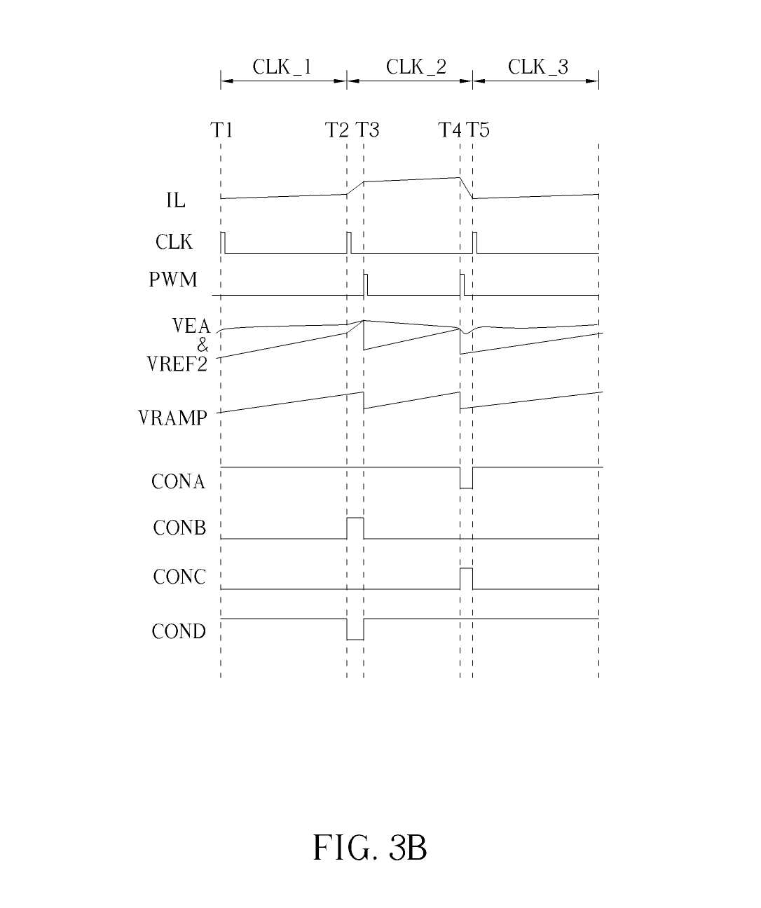

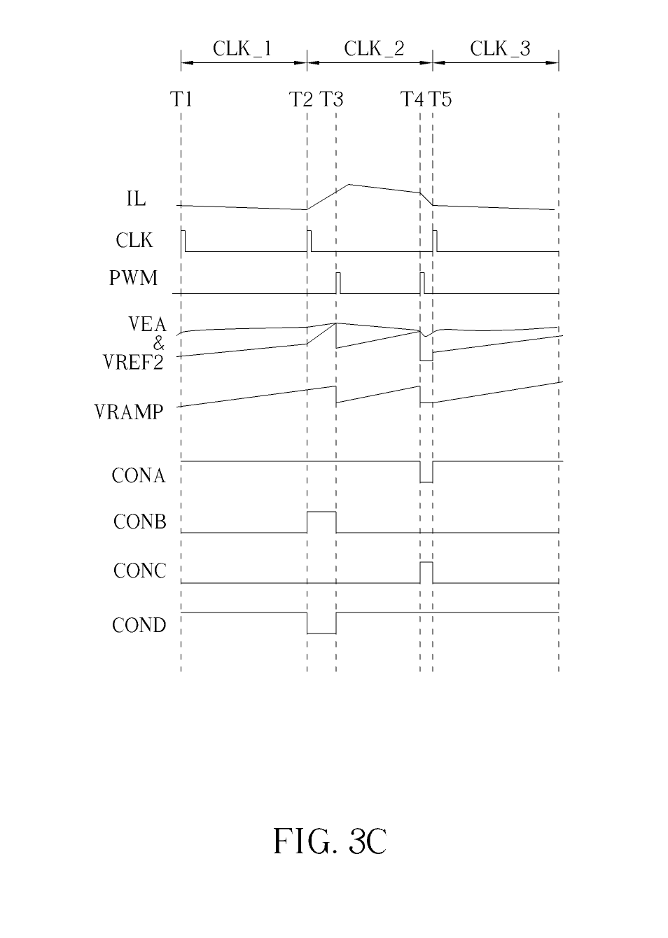

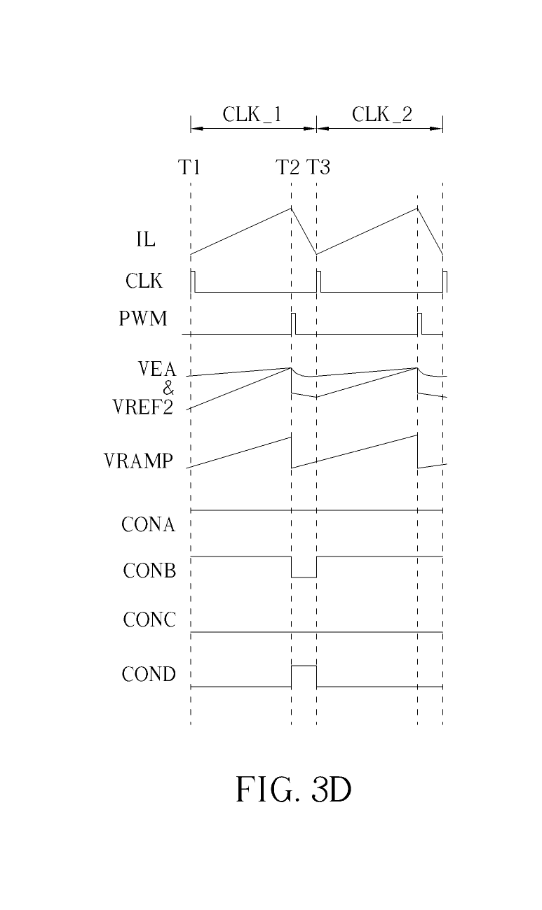

Please refer to FIGS. 3A-3D, which are schematic diagrams of related signals when the power converting device 20 shown in FIG. 2 operates in different operating statuses. FIG. 3A is a schematic diagram of related signals when the power converting circuit 20 shown in FIG. 2 operates in the buck mode. As shown in FIG. 3A, the clock signal CLK uses a pulse for instructing the clock period CLK_1 to begin and the pulse width modulation signal PWM is at the low logic level at a time T1. The control signals CONA, COND are at the high logic level and the control signal CONB, CONC are at the low logic level, such that the switches SA, SD are conductive and the switches SB, SC are disconnected. The input voltage VIN provides the energy to the output end OUT and stores energy to the inductor L. The slope compensation control signal D_CRAMP is at the high logic level at the time T1, such that the ramp voltage VRAMP rises from the ground voltage in a constant slope. Since the input voltage VIN is greater than the output voltage, the inductor current IL rapidly rises, thus the reference voltage VREF2 exceeds the error voltage VEA at a time T2 within the clock period CLK_1. When the pulse width modulation signal PWM uses a pulse for instructing the reference voltage VREF2 to exceed the error voltage VEA, the control signals CONA, CONC is switched. The switches SC, SD are conductive and the switches SA, SB are disconnected, such that the inductor L starts to distribute stored energy to the output end OUT. In such a condition, the current signal ISA is reset to 0 because the switch SA is disconnected. The slope compensation control signal D_CRAMP is switched to the low logic level and the ramp voltage VRAMP is reset and maintained at the low logic level. Next, when the clock signal CLK uses a pulse for instructing the next clock period CLK_2 to begin at a time T3 and the pulse width modulation signal PWM is at the low logic level, the control signals CONA, CONC are switched. The switches SA, SD are conductive and the switches SB, SC are disconnected, such that the power converting device 20 backs to the default status. On the other hand, the slope compensation control signal D_CRAMP is switched at the time T3, and then the ramp voltage VRAMP rises from the ground voltage in the constant slope. Via repeating the operations between the time T1 to the time T3 (i.e. the clock period CLK_1), the power converting device 20 operates in the buck mode. In other words, the power converting device 20 only has to switch the switch SA and the switch SC to operate in the buck mode. As a result, the average power consumption of the power converting device 20 is effectively reduced through minimizing the switching times of the switches SA-SD.

Please refer to FIG. 3B, which is a schematic diagram of related signals when the power converting device 20 shown in FIG. 2 operates and the input voltage VIN is slightly greater than the output voltage VOUT. At the time T1, the clock signal CLK uses a pulse for instructing the clock period CLK_1 to begin and the pulse width modulation signal PWM is at the low logic level. The control signals CONA, COND are at the high logic level and the control signal CONB, CONC are at the low logic level, such that the switches SA, SD are conductive and the switches SB, SC are disconnected. The input voltage VIN provides the energy to the output end OUT and stores energy in the inductor L. The slope compensation control signal D_CRAMP is at the high logic level at the time T1, such that the ramp voltage VRAMP rises from the ground voltage in a constant slope. Since the input voltage is slightly greater than the output voltage VOUT, the inductor current slowly rises, thus the reference voltage VREF2 cannot exceed the error voltage VEA within the clock period CLK_1. When the clock signal CLK uses a pulse for instructing the clock period CLK_2 to begin at a time T2, the control signals CONB, CONC are switched. The switches SA, SB is conductive and the switches SC, SD are disconnected, such that the inductor current IL quickly rises. In such a condition, the reference voltage VREF2 will exceed the error voltage VEA at a time T3 within the clock period CLK_2. The pulse width modulation signal PWM generates a pulse for switching the control signals CONB, COND. The switches SA, SD are conductive and the switches SB, SC are disconnected. The slope compensation control signal D_CRAMP generates a pulse for resetting the ramp voltage VRAMP to the ground voltage, and then the ramp voltage VRAMP rises in the constant slope. Since the input voltage VIN is slightly greater than the output voltage VOUT, the inductor current IL is continuously and slowly raised. The reference voltage VREF2 will exceed the error voltage VEA at a time. The pulse width modulation signal PWM generates a pulse for instructing the reference voltage VREF2 to exceed the error voltage VEA within the clock period CLK_2 again, such that the control signals CONA, CONC are switched. Accordingly, the switches SC, SD are conductive and the switches SA, SB are disconnected, and then the inductor L begins to distribute the stored energy to the output end OUT. The slope compensation control signal D_CRAMP is switched for resetting and maintaining the ramp voltage VRAMP at the ground voltage. Finally, when the clock signal CLK instructs the clock period CLK_3 to start at the time T5 and the pulse width modulation is at the low logic level, the control signals CONA, CONC and the slope compensation control signal are switched. The switches SA, SD are conductive, the switches SB, SC are disconnected, and the ramp voltage VRAMP is raised from the ground voltage in a constant slope. Via repeating the pattern from the time T1 to the time T5, the power converting device 20 operates in the buck-boost mode. As can be seen from the above, the power converting device 20 effectively prolongs the time that the switches SA, SD are simultaneously conductive when the power converting device 20 operates in the buck-boost mode. The conducting loss of the power converting device 20 is decreased and the conversion efficiency of the power converting device 20 is increased. In addition, when the power converting device 20 operates in the buck-boost mode, the operations of the power converting device 20 becomes smoother via simultaneously conducting the switch SA and the switch SD. The ripples of the output voltage VOUT are lessened.

Please refer to FIG. 3C, which is a schematic diagram of related signals when the power converting device 20 shown in FIG. 2 operates and the input voltage VIN is slightly greater than the output voltage VOUT. As shown in FIG. 3C, the operations of the power converting device 20 are similar to the operations shown in FIG. 3B. The difference between FIG. 3B and FIG. 3C is that the times T3, T4 shown in FIG. 3C are postponed because the input voltage VIN is slightly smaller than the output voltage VOUT and the inductor current IL is slowly dropped. As a result, the power converting device 20 effectively prolongs the time that the switches SA, SD are simultaneously conductive when the input voltage VIN is slightly smaller than the output voltage VOUT. The conducting loss of the power converting device 20 is decreased and the conversion efficiency of the power converting device 20 is increased.

When the input voltage VIN drops, the power converting device 20 will operate in the boost mode. Please refer to FIG. 3D, which is a schematic diagram of related signals when the power converting device 20 shown in FIG. 2 operates in the boost mode. When the clock signal CLK instructs the clock period CLK_1 to begin at the time T1 and the pulse width modulation is at the low logic level, the control signals CONA, CONB are at the high logic level and the control signals CONC, COND are at the low logic level. The switches SA, SB are conductive and the switches SC, SD are disconnected, such that the inductor current IL is quickly raised. The reference voltage VREF2 exceeds the error voltage VEA at the time T2. The pulse width modulation signal PWM generates a pulse for switching the control signals CONB, COND, resulting in the switches SA, SD being conductive and the switches SB, SD being disconnected. At the same time, the slope compensation control signal generates a pulse for resetting the ramp voltage VRAMP, and then the ramp voltage VRAMP is raised from the ground voltage in the constant slope. Since the input voltage VIN is smaller than the output voltage VOUT, the inductor current IL is rapidly dropped. The reference voltage VREF2 will not exceed the error voltage VEA within the clock period CLK_1. Next, the clock signal CLK instructs the clock period CLK_2 begins at a time T3 and the control signals CONB, COND are switched, such that the switches SA, SB are conductive and the switches SC, SD are disconnected. The inductor current is rapidly raised. The power converting device 20 repeats the operations from the time T1 to the time T3 and operates in the boost mode. Please note that the power converting device 20 only has to switch the switch SB and the switch SD in a clock period when operating in the boost mode. In other words, the average power consumption of the power converting device 20 is effectively decreased via minimizing the switching times of the switch SB and the switch SD.

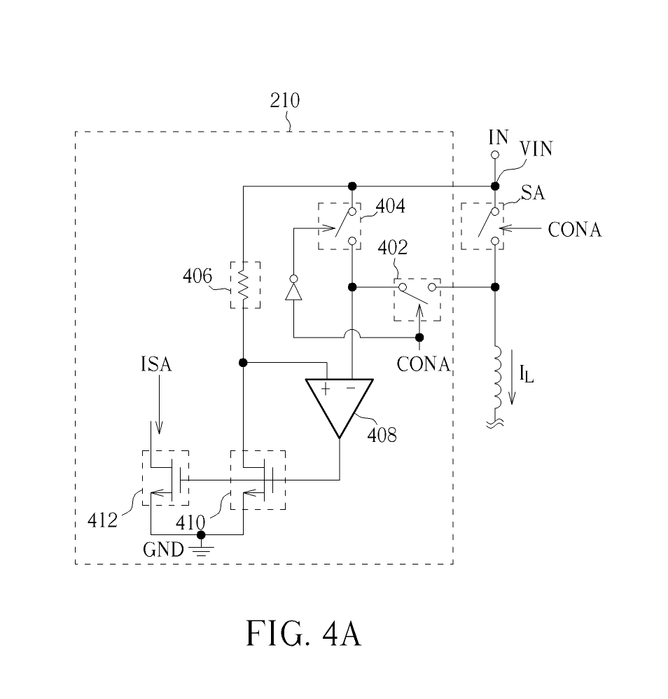

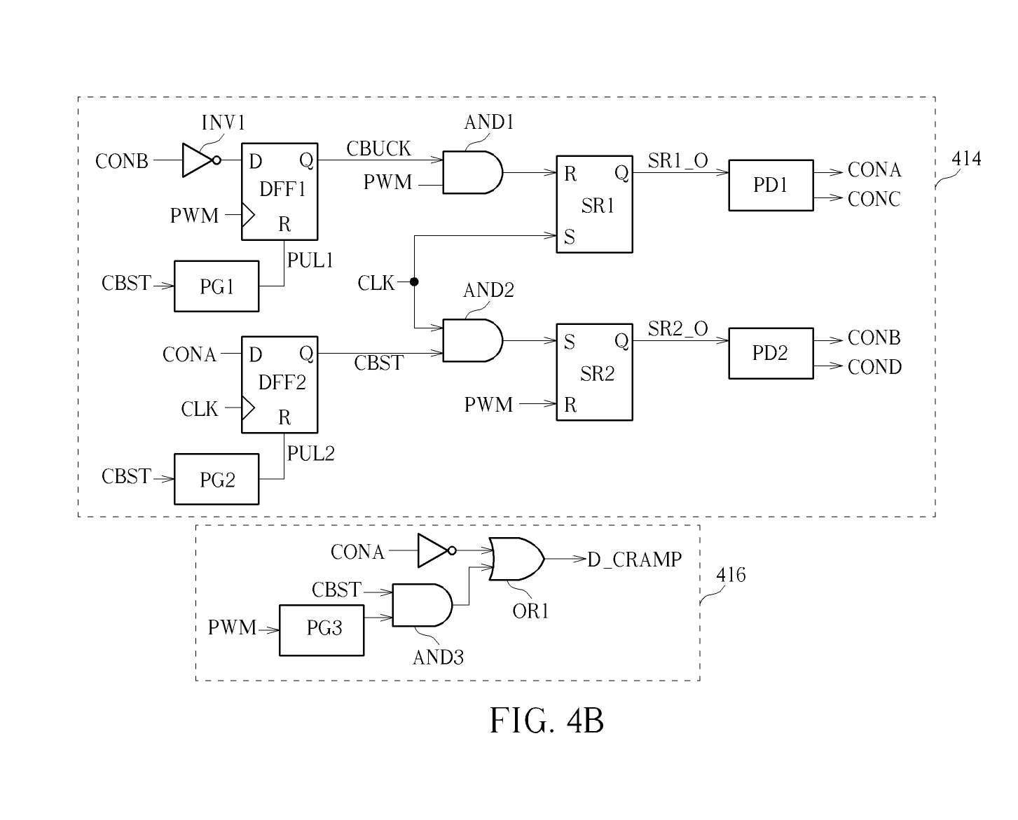

The power converting device 20 shown in FIG. 2 is an exemplary embodiment of the present invention which uses block diagrams for explaining the concepts of the present invention. The realization method of each block and the forms and the generating methods of related signals can be modified according to different system requirements. For example, please refer to FIGS. 4A, 4B, which are schematic diagrams of realization methods of the current detecting unit 212 and the logic control module 206 shown in FIG. 2. As shown in FIG. 4A, the current detecting unit 212 comprises an inverter 400, switches 402, 404, a sensing resistor 406, an operational amplifier 408 and transistors 410, 412. The connections between each component of the current detecting unit 212 are shown in FIG. 4A. The operating methods of the current detecting unit 212 should be well known to those skilled in the art, and are not described herein for brevity. Please refer to FIG. 4B: the logic control module 206 comprises a control signal generating unit 414 and a compensation generating unit 416. The control signal generating unit 414 is utilized for generating the control signals CONA-COND according to the pulse width modulation signal PWM and the clock signal CLK. The compensation signal generating unit 416 is utilized for generating the slope compensation control signal D_CRAMP according to the control signal CONA and the pulse width modulation signal PWM.

Specifically, the control signal generating unit 414 comprises an inverter INV1, pulse generators PG1, PG2, D-flip-flops DFF1, DFF2, AND gates AND1, AND2, SR latches SR1, SR2 and pre-drivers PD1, PD2. The connections between each component of the control signal generating unit 414 are shown in FIG. 4B. The inverter INV1 is utilized for generating an inverted signal CONB_I according to the control signal CONB. The pulse generator PG1 is utilized for generating a pulse signal PUL1 according to a signal CBST. The pulse generator PG2 is utilized for generating a pulse signal PUL2 according to a signal CBUCK. The D-flip-flip DFF1 is utilized for generating the signal CBUCK according to the pulse width modulation signal PWM, the inverted signal CONB_I and the pulse signal PUL1. The D-flip-flip DFF2 is utilized for generating the signal CBST according to the clock signal CLK, the control signal CONA and the pulse signal PUL2. The AND gate AND1 is utilized for receiving the signal CBUCK and the pulse width modulation signal PWM, to generate a signal AND1_O. The AND gate AND2 is utilized for receiving the signal CBST and the clock signal CLK, to generate a signal AND2_O. The SR latch SR1 is utilized for generating a signal SR1_O according to the signal AND1_O and the clock signal CLK. The SR latch SR2 is utilized for generating a signal SR2_O according to the signal AND2_O and the pulse width modulation signal PWM. The pre-driver PD1 is utilized for generating the control signals CONA, CONC according to the signal SR1_O. The pre-driver PD2 is utilized for generating the control signals CONB, COND according to the signal SR2_O. In a preferable embodiment, the pre-drivers PD1, PD2 generate appropriate control signals CONA-COND to avoid the switches SA, SC or the switches SB, SD being conductive at the same time.

The compensation signal generating unit 416 comprises an inverter INV2, a pulse generator PG3, an AND gate AND3 and an OR gate OR1. The connections between each component of the compensation signal generating unit 416 are shown in FIG. 4B. The inverter INV2 is utilized for generating an inverted signal CONA_I according to the control signal CONA. The pulse generator PG3 is utilized for generating a pulse signal PUL3 according to the pulse width modulation signal PWM. The AND gate AND3 is utilized for generating a signal AND3_O according to the pulse signal PUL3 and the signal CBST of the control signal generating unit 414. The OR gate OR1 is utilized for generating the slope compensation control signal D_CRAMP according to the inverted signal CONA_I and the signal AND3_O. As a result, the logic control module 206 can generate appropriate control signals CONA-COND and the slope compensation control signal D_CRAMP via the control signal generating unit 414 and the compensation signal generating unit 416, to control the conducting sequences of the switches SA-SD according to different operating status.

The detailed operational methods of the control signal generating unit 414 and the compensation signal generating unit 416 are narrated as follows. When the control signals CONA, CONB are at the low logic level and the control signals CONC, COND are at the high logic level (i.e. when the switches SA, SB are disconnected and the switches SC, SD are conductive), the signal BST, SR1_O, SR2_O are at the low logic level and the signal BUCK is at the high logic level. If a rising edge appears in the clock signal CLK for instructing a clock period to begin, the signal CBST is maintained at the low logic level and the signal SR1_O is switched to the high logic level, resulting in the control signals CONA, CONC being switched for conducting the switch SA and disconnecting the switch SC. Next, if another rising edge appears in the clock signal CLK for instructing a next clock period to begin, the signal BST, SR2_O is switched, resulting in the control signals CONB, COND being switched for conducting switch SB and disconnecting switch SD. The pulse generator PG1 generates a pulse to the D-flip-flop DFF1 when the signal CBST is switched to the high logic level, for resetting the signal CBUCK to the low logic level such that the control signal CONA is maintained at the high logic level (i.e. the switch SA is continuously conductive) and the control signals CONB, CONC are alternately at the high logic level (i.e. the switch SB and the switch SC are not conductive at the same time).

When the control signals CONA, CONB are at the high logic level and the control signals CONC, COND are at the low logic level (i.e. the switches SA, SB are conductive and the switches SC, SD are disconnected), the signal BSA, SR1_O, SR2_O are at the high logic level and the signal CBUCK is at the low logic level. If a rising edge appears in the pulse width modulation signal PWM, the signal SR2_O is reset to the low logic level, resulting in the control signals CONB, COND being switched for disconnecting the switch SB and conducting the switch SD. If another rising edge appears at the pulse width modulation signal PWM, the signals CBUCK, SR1_O are switched, such that the control signals CONA, CONC are switched for disconnecting the switch SA and conducting the switch SC. In addition, the pulse generator PG2 generates a pulse to D-flip-flop DFF2 when the signal CBUCK is switched to the low logic level, for resetting the signal CBST to the low logic level and maintaining the control signal COND at the high logic level (i.e. the switch SD is continuously conductive).

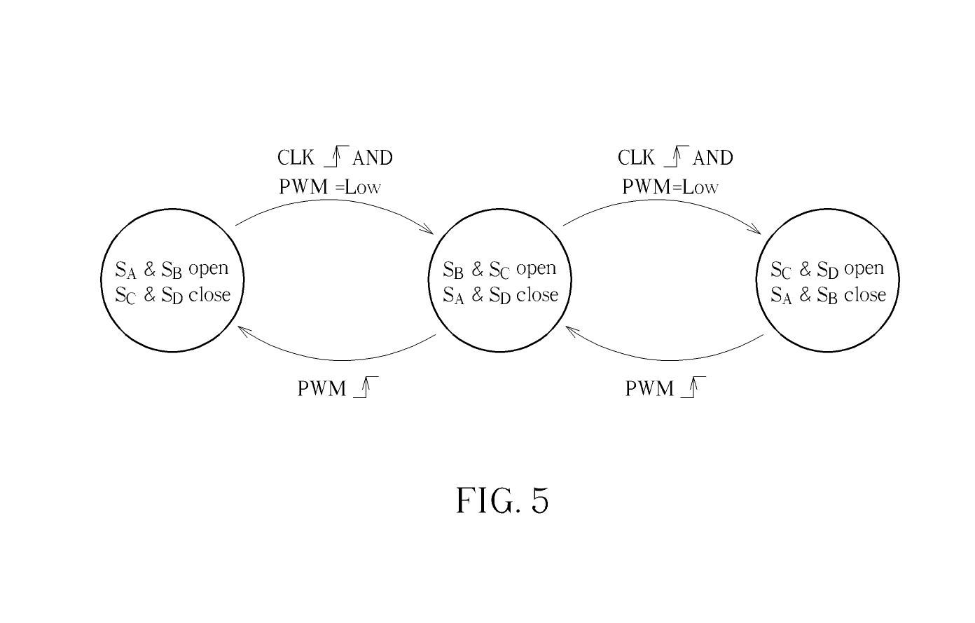

Please refer to FIG. 5, which is a schematic diagram of a state machine executed by the control signal generating unit 414. As shown in FIG. 5, if a rising edge appears in the clock signal CLK and the pulse modulation signal PWM is maintained at the logic level when the switches SA, SB are disconnected and the switches SC, SD are conductive, the control signal generating unit 414 generates appropriate control signals CONA-COND for disconnecting the switches SB, SC and conducting the switches SA, SD. Similarly, if a rising edge appears in the clock signal CLK and the pulse modulation signal PWM is maintained at the logic level when the switches SB, SC are disconnected and the switches SA, SD are conductive, the control signal generating unit 414 generates appropriate control signals CONA-COND for disconnecting the switches SC, SD and conducting the switches SA, SB. Alternatively, if a rising edge appears in the pulse modulation signal PWM when the switches SB, SC are disconnected and the switches SA, SD are conductive, the control signal generating unit 414 generates appropriate control signals CONA-COND for disconnecting the switches SA, SB and conducting the switches SC, SD. Finally, if a rising edge appears in the pulse modulation signal PWM when the switches SA, SB are disconnected and the switches SC, SD are conductive, the control signal generating unit 414 generates appropriate control signals CONA-COND for disconnecting the switches SB, SC and conducting the switches SA, SB. As a result, the control signal generating unit 414 can avoid simultaneously switching the switches SA-SD, and thus the conducting loss is decreased.

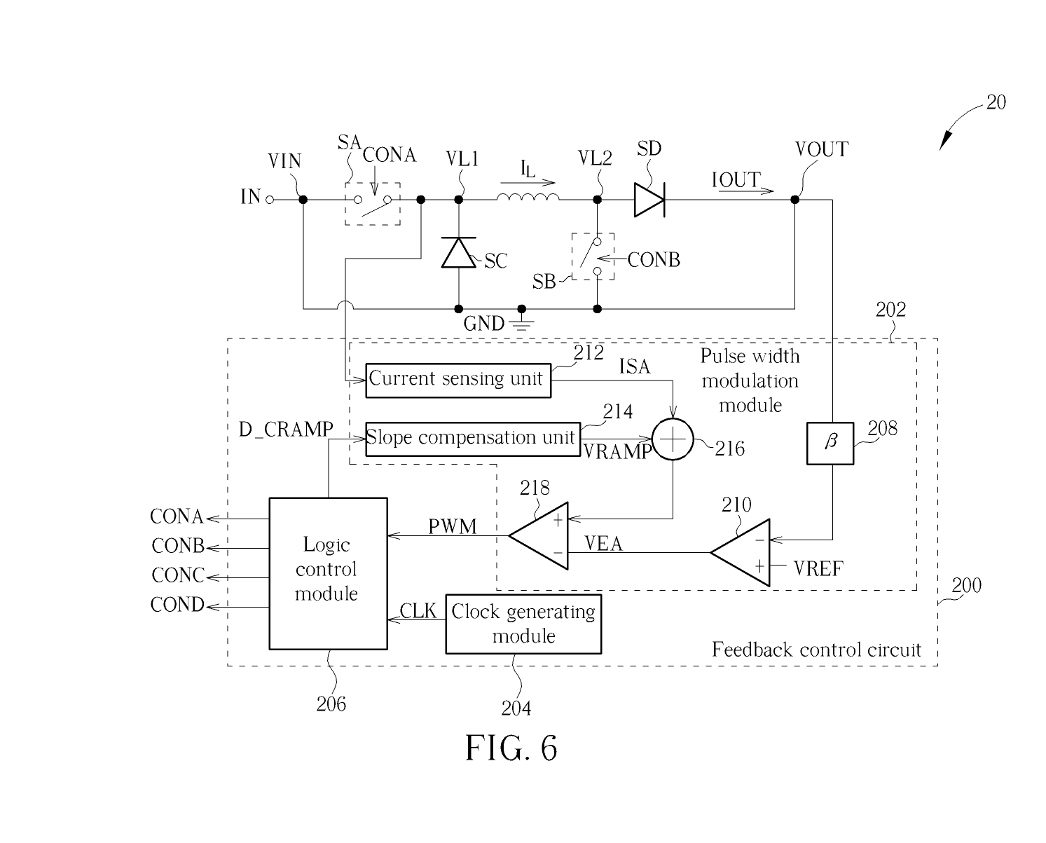

Please note that the main spirit of the present invention is controlling the conducting sequences of the switches SA-SD via detecting the switch current of the switch SA and the output voltage VOUT, for prolonging the time that the switches SA, SD are simultaneously conductive when the power converting device operates in the buck-boost mode. Thus, the conducting loss of the power converting device can be effectively decreased. Furthermore, the switches SA-SD will not be switched at the same time according to the conducting sequences of the present invention, such that the output voltage VOUT can be more stable. Moreover, the switching times of the switches SA-SD are minimized, thus the switching loss of the power converting device can be decreased. According to different applications, those skilled in the art may observe appropriate modifications. Please refer to FIG. 6, which is a schematic diagram of a power converting device 60 according to another embodiment of the present invention. The structure of the power converting device 60 is similar to that of the power converting device 20 shown in FIG. 2, thus the same symbols are used. Different from the power converting device 20, the power switches SC and SD are realized by passive components (i.e. diodes). The detailed operation methods of the power converting device 60 can be known by referring to the power converting device 20, and are not narrated herein for brevity.

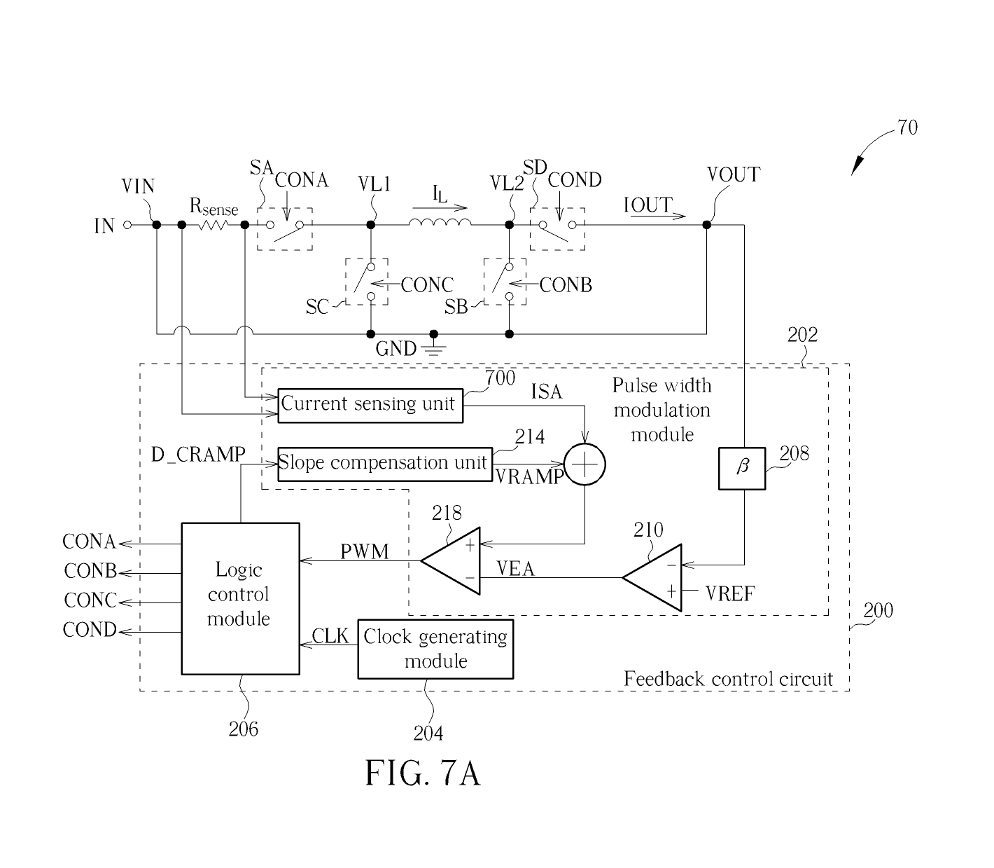

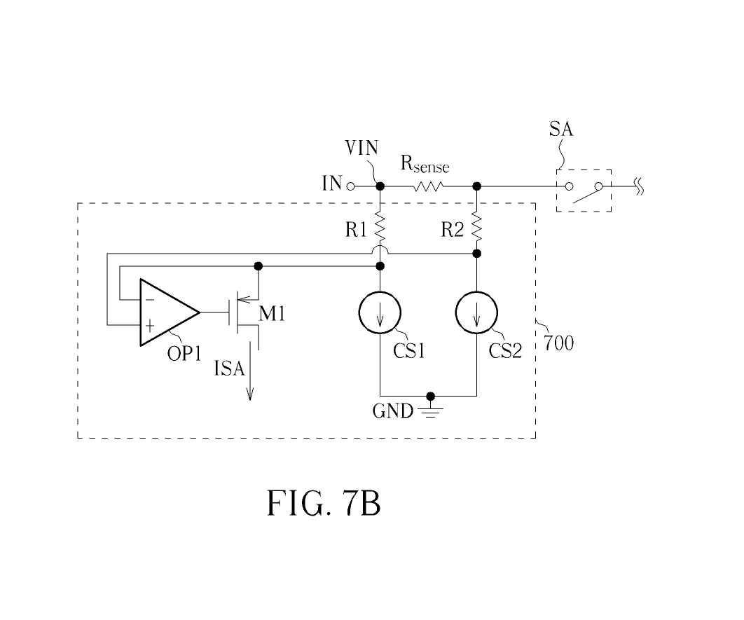

The method of detecting the switch current of the switch SA can be realized by other methods. Please refer to FIG. 7A, which is a schematic diagram of a power converting device 70 according to another embodiment of the present invention. The structure of the power converting device 70 is similar to that of the power converting device 20 shown in FIG. 2, thus the same symbols are used. Different from the power converting device 20, a sensing resistor Rsense is added in the power converting device 70 and is coupled between the switch SA and the input voltage VIN. Please refer to FIG. 7B, which is a schematic diagram of a current sensing unit 700 of the power converting device 70. The current sensing unit 700 comprises resistors R1, R2, current sources CS1, CS2, an operational amplifier OP1 and a transistor M1. The connections between each component of the current sensing unit 700 are shown in FIG. 7B. The operational methods of the current sensing unit 700 should be well known to those with ordinary skill and are not narrated herein for brevity. As a result, the power converting device 70 can use different current sensing methods to acquire information concerning the switch current of the switch SA.

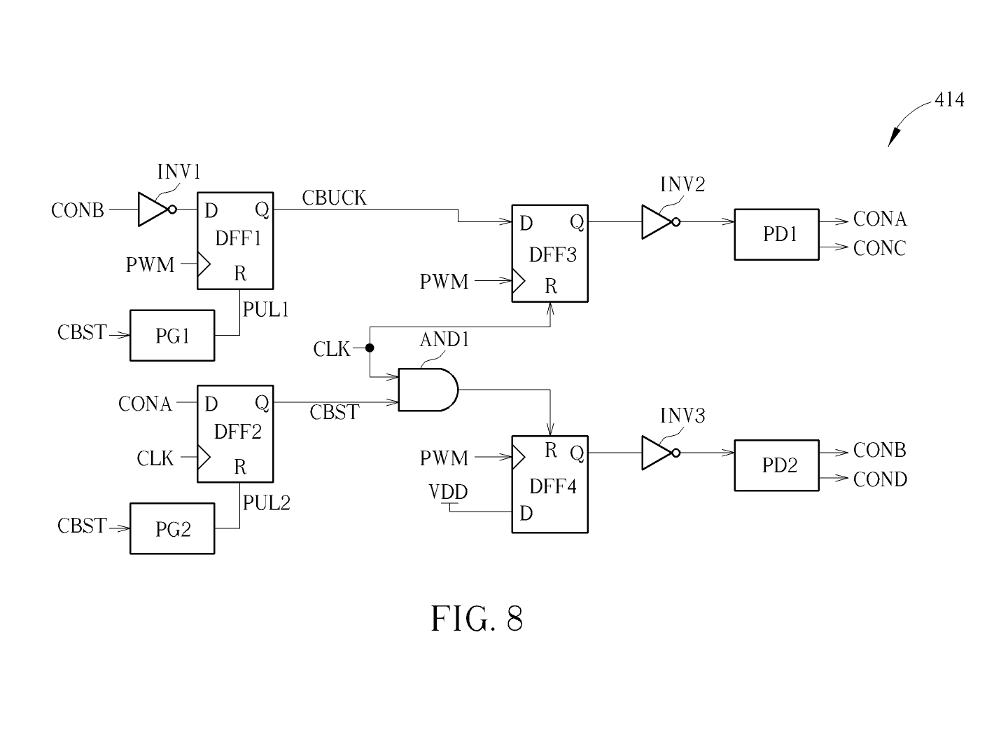

The control signal generating unit 414 can also be realized by different implementation methods. Please refer to FIG. 8, which is a schematic diagram of another implementation method of the control signal generating unit 414. As shown in FIG. 8, the control signal generating unit 414 comprises inverters INV1-INV3, the pulse generators PG1, PG2, D-flip-flops DFF1-DFF4, an AND gate AND1 and pre-drivers PD1, PD2. The connections between each component of the control signal generating unit 414 are shown in FIG. 8. The detailed operation methods of the control signal generating unit 414 shown in FIG. 8 can be known by referring to the control signal generating unit 414 shown in FIG. 4, and are not narrated herein for brevity.

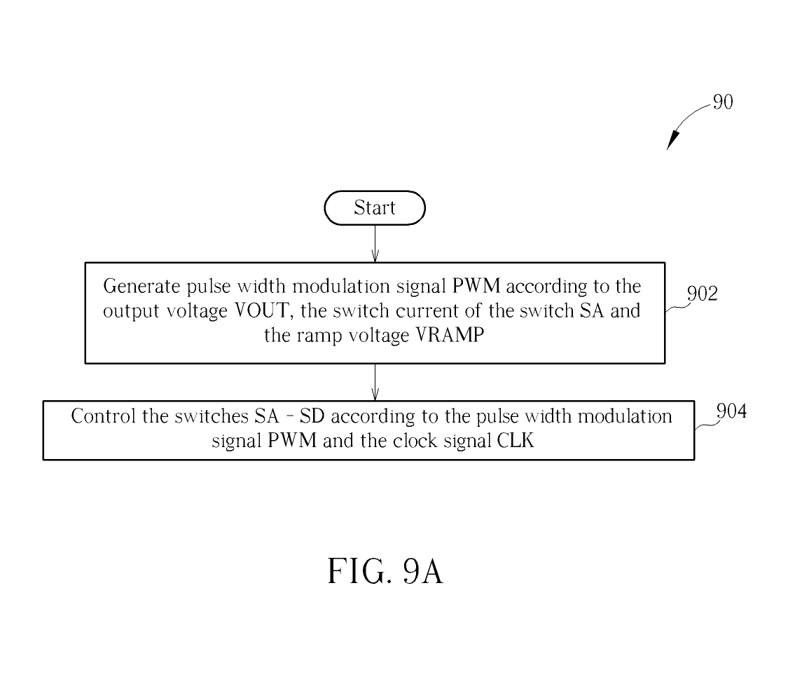

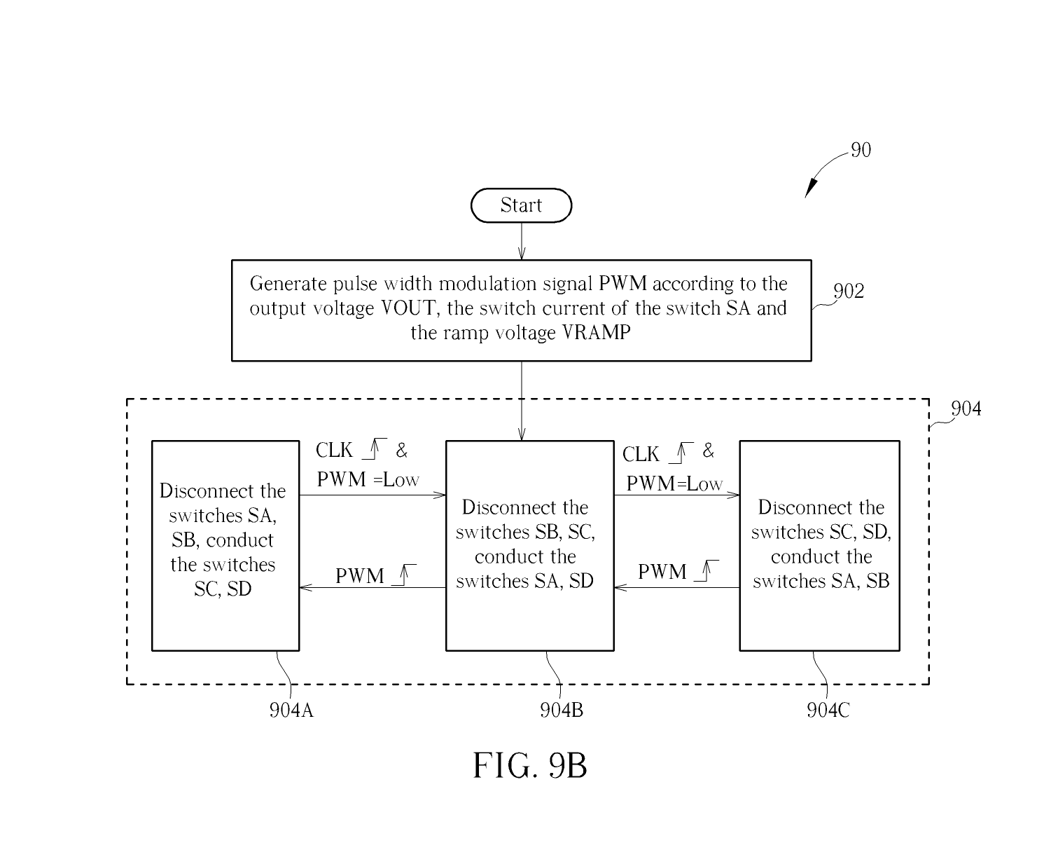

The operating procedures of the feedback control circuit 200 can be summarized by a method 90 for controlling the power converting device 20. Please refer to FIG. 9A, which is a schematic diagram of the method 90 according to an embodiment of the present invention. The method 90 comprises the following steps:

Step 900: Start.

Step 902: Generate pulse width modulation signal PWM according to the output voltage VOUT, the switch current of the switch SA and the ramp voltage VRAMP.

Step 904: Control the switches SA-SD according to the pulse width modulation signal PWM and the clock signal CLK.

According to the method 90, the power converting device 20 can appropriately control the conducting sequences of the switches SA-SD via the switch current of the switch SA and the output voltage VOUT. Thus, the time that the switches SA, SD are simultaneously conductive while operating can be effectively prolonged and the switching times of the switches SA-SD is minimized. The average power consumption of the power converting device 20 is accordingly decreased.

In detail, the output voltage VOUT is divided for generating the feedback voltage VFB. Then, the error voltage VEA is generated by subtracting the feedback voltage FB from the reference voltage VREF1. According to the switch current of the switch SA, the current signal ISA which is proportional to the switch current of the switch SA is generated. The reference voltage VREF2 is generated by adding the current signal ISA and the ramp voltage VRAMP. The ramp voltage VRAMP is the ground voltage when the switch SA is disconnected, and is increased in a specific slope when the switch SA is conductive and the switches SB, SD are alternately conductive. As a result, the pulse width modulation signal PWM, which represents whether the inductor L stores sufficient energy for providing the output end OUT, is generated by comparing the reference voltage VREF2 and the error voltage VEA.

After acquiring the pulse width modulation signal PWM, the conducting sequences of the switches SA-SD can be controlled according to the pulse width modulation signal PWM and the clock signal CLK. Please refer to FIG. 9B, which is a schematic diagram of an implementation method of the step 904 of the method 90 shown in FIG. 9A. As shown in FIG. 9B, the step 904 comprises:

Step 904A: Disconnect the switches SA, SB, conduct the switches SC, SD and execute step 904B when the clock signal CLK instructs a clock period to begin and the pulse width modulation signal PWM is at the low logic level.

Step 904B: Disconnect the switches SB, SC, conduct the switches SA, SD, execute step 904C when the clock signal CLK instructs a clock period to begin and the pulse width modulation signal PWM is at the low logic level and execute the step 904A when the pulse width modulation signal PWM instructs the inductor L to store sufficient energy.

Step 904C: Disconnect the switches SC, SD, conduct the switches SA, SB and execute the step 904B when the pulse width modulation signal PWM instructs the inductor L to store sufficient energy.

In a preferable embodiment, the power converting device 20 disconnects the switches SB, SC and conducts the switches SA, SD in the default status (i.e. Step 904B). As a result, the time that the switches SA, SD are simultaneously conductive will be effectively prolonged and the switching times of the switches SA-SD will be minimized. The average power consumption of the power converting device 20 is accordingly decreased.

To sum up, the method and related circuit disclosed by the above embodiments utilize the peak current mode to control the switch conducting sequences of the power converting device. In comparison with the prior art, the above embodiments do not need complicated circuitry for measuring the average current of the inductor. Moreover, the power converting device can smoothly switch switches while operating in the buck-boost mode according to the conducting sequences of the above embodiments. The conducting loss and the switching loss of the power converting device are accordingly decreased. The average power consumption of the power converting device can be effectively decreased through adapting the method and circuit thereof disclosed by the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling a power converting device which comprises an inductor, a first switch coupled between an input end and a first node of the inductor, a second switch coupled between a second node of the inductor and ground, a third switch coupled between the first node of the inductor and ground and a fourth switch coupled between the second node of the inductor and an output end, the method comprising:
generating a pulse width modulation signal according to an output voltage of the output end, a switch current of the first switch and a ramp voltage; and
controlling the first switch, the second switch, the third switch and the fourth switch according to the pulse width modulation signal and a clock signal.

2. The method of claim 1, wherein the ramp voltage is the ground voltage when the first switch is disconnected.

3. The method of claim 1, wherein while the first switch is conductive, the second switch and the fourth switch are alternately conductive, the ramp voltage is reset to the ground voltage and is increased in a specific slope when the pulse width modulation signal instructs an error voltage to be smaller than a second reference voltage.

4. The method of claim 1, wherein the step of generating the pulse width modulation signal according to the output voltage of the output end, the switch current of the first switch and the ramp voltage comprises:
generating a feedback voltage according to the output voltage;
generating an error voltage according to the feedback voltage and a first reference voltage;
detecting the switch current for acquiring a current voltage;
adding the current voltage and the ramp voltage, for acquiring a second reference voltage; and
comparing the error voltage and the second reference voltage, for generating the pulse width modulation signal.

5. The method of claim 4, wherein the step of controlling the first switch, the second switch, the third switch and the fourth switch according to the pulse width modulation signal and the clock signal comprises:
when the first switch and the fourth switch are conductive, the second switch and the third switch are disconnected, the clock signal instructs a clock period to begin and the pulse width modulation signal instructs the error voltage to be greater than the second reference voltage, and then conducting the first switch and the second switch and disconnecting the third switch and the fourth switch.

6. The method of claim 4, wherein the step of controlling the first switch, the second switch, the third switch and the fourth switch according to the pulse width modulation signal and the clock signal comprises:
when the first switch and the fourth switch are conductive, the second switch and the third switch are disconnected and the pulse width modulation signal instructs the error voltage to be smaller than the second reference voltage, and then conducting the third switch and the fourth switch and disconnecting the first switch and the second switch.

7. The method of claim 4, wherein the step of controlling the first switch, the second switch, the third switch and the fourth switch according to the pulse width modulation signal and the clock signal comprises:
when the first switch and the second switch are conductive, the third switch and the fourth switch are disconnected and the pulse width modulation signal instructs the error voltage to be smaller than the second reference voltage, and then conducting the first switch and the fourth switch and disconnecting the second switch and the third switch.

8. The method of claim 4, wherein the step of controlling the first switch, the second switch, the third switch and the fourth switch according to the pulse width modulation signal and the clock signal comprises:
when the third switch and the fourth switch are conductive, the first switch and the second switch are disconnected, the clock signal instructs a clock period to begin and the pulse width modulation signal instructs the error voltage to be greater than the second reference voltage, and then conducting the first switch and the fourth switch and disconnecting the second switch and the third switch.

9. A feedback control circuit for a power converting device which comprises an inductor, a first switch, a second switch, a third switch and a fourth switch, comprising:
a pulse width modulation module, comprising:
a voltage dividing unit coupled to an output end of the power converting device for outputting a feedback voltage according to an output voltage of the power converting device;
an error amplifier, coupled to the voltage dividing unit for generating an error voltage according to the feedback voltage and a first reference voltage;
a current detecting unit, for detecting a switch current of the first switch;
a slope compensation unit, for generating a ramp voltage according to a slope compensation control signal;
an adding unit, coupled to the current detecting unit and the slope compensation unit for generating a second reference voltage according to the switch current and the ramp voltage; and
a comparing unit, coupled to the error amplifier and the adding unit for generating a pulse width modulation signal according to the error voltage and the second reference voltage signal;
a clock generating module, for generating a clock signal; and
a logic control module, for generating a first control signal, a second control signal, a third control signal, a fourth control signal and the slope compensation control signal according to the clock signal and the pulse width modulation signal, to separately control the first switch, the second switch, the third switch and the fourth switch.

10. The feedback control circuit of claim 9, wherein the logic control module adjusts the slope compensation control signal for resetting the ramp voltage to the ground end when the first switch is disconnected.

11. The feedback control circuit of claim 9, wherein while the first switch is conductive and the second switch and the fourth are alternately conductive, the logic control module adjusts the slope compensation control signal for resetting the ramp voltage to the ground voltage and increasing the ramp voltage in a constant slope when the pulse width modulation signal instructs the error voltage to be smaller than the second reference voltage.

12. The feedback control circuit of claim 9, wherein when the first switch is conductive, the second switch is disconnected, the third switch is disconnected, the fourth switch is conductive, the clock signal instructs a clock period to begin and the pulse width modulation signal instructs the error voltage to be greater than the second reference voltage, and the logic control module then conducts the first switch and the second switch and disconnects the third switch and the fourth switch through the first control signal, the second control signal, the third control signal and the fourth control signal.

13. The feedback control circuit of claim 9, wherein when the first switch is conductive, the second switch is disconnected, the third switch is disconnected, the fourth switch is conductive and the pulse width modulation signal instructs the error voltage to be smaller than the second reference voltage, and the logic control module then conducts the third switch and the fourth switch and disconnects the first switch and the second switch through the first control signal, the second control signal, the third control signal and the fourth control signal.

14. The feedback control circuit of claim 9, wherein when the first switch is conductive, the second switch is conductive, the third switch is disconnected, the fourth switch is disconnected and the pulse width modulation signal instructs the error voltage to be smaller than the second reference voltage, and the logic control module then conducts the first switch and the fourth switch and disconnects the second switch and the third switch through the first control signal, the second control signal, the third control signal and the fourth control signal.

15. The feedback control circuit of claim 9, wherein when the first switch is disconnected, the second switch is disconnected, the third switch is conductive, the fourth switch is conductive, the clock signal instructs a clock period to begin and the pulse width modulation signal instructs the error voltage to be greater than the second reference voltage, and the logic control module then conducts the first switch and the fourth switch and disconnects the second switch and the third switch through the first control signal, the second control signal, the third control signal and the fourth control signal.

16. The feedback control circuit of claim 9, wherein the logic control module comprises:
a control signal generating unit, comprising:
a first inverter, for outputting an inverted second control signal;
a first flip-flop, comprising a data end for receiving the inverted second control signal, a clock end for receiving the pulse width modulation signal, a reset end for receiving a first impulse signal and an output end for outputting a buck signal;
a second flip-flop, comprising a data end for receiving the first control signal, a clock end for receiving the clock signal, a reset end for receiving a second impulse signal and an output end for outputting a boost signal;
a first impulse generator, comprising an input end for receiving the boost signal and an output end for outputting the first impulse signal;
a second impulse generator, comprising an input end for receiving the buck signal and an output end for outputting the second impulse signal;
a first AND gate, comprising a first input end for receiving the buck signal, a second input end for receiving the pulse width modulation signal and an output end;
a second AND gate, comprising a first input end for receiving the boost signal, a second input end for receiving the clock signal and an output end;
a third flip-flop, comprising a reset end coupled to the output end of the first AND gate, a set end for receiving the clock signal and an output end;
a fourth flip-flop, comprising a reset end for receiving the pulse width modulation signal, a reset end coupled to the output end of the second AND gate and an output end;
a first pre-driver, comprising an input end coupled to the output end of the third flip-flop, a first output end for outputting the first control signal and a second output end for outputting the third control signal; and
a second pre-driver, comprising an input end coupled to the output end of the fourth flip-flop, a first output end for outputting the second control signal and a second output end for outputting the fourth control signal; and
a compensation signal generating unit, comprising:
a third impulse generator, comprising an input end for receiving the pulse width modulation signal and an output end for outputting a third impulse signal;
a third AND gate, comprising a first input end for receiving the third impulse signal, a second input end for receiving the boost signal and an output end;
a second inverter, for outputting the inverted first control signal; and
an OR gate, comprising a first input end coupled to the output end of the third AND gate, a second input end coupled to the output end of the second inverter and an output end for outputting the slope compensation control signal.

17. The feedback control circuit of claim 9, wherein the logic control module comprises:
a control signal generating unit, comprising:
a first inverter, for outputting an inverted second control signal;
a first flip-flop, comprising a data end for receiving the inverted second control signal, a clock end for receiving the pulse width modulation signal, a reset end for receiving a first impulse signal and an output end for outputting a buck signal;
a second flip-flop, comprising a data end for receiving the first control signal, a clock end for receiving the clock signal, a reset end for receiving a second impulse signal and an output end for outputting a boost signal;
a first impulse generator, comprising an input end for receiving the boost signal and an output end for outputting the first impulse signal;
a second impulse generator, comprising an input end for receiving the buck signal and an output end for outputting the second impulse signal;
a first AND gate, comprising a first input end for receiving the boost signal, a second input end for receiving the clock signal and an output end;
a third flip-flop, comprising a data end for receiving a system maximum voltage, a clock end for receiving the pulse width modulation signal, a reset end for receiving the clock signal and an output end;
a fourth flip-flop, comprising a data end for receiving the buck signal, a clock end for receiving the pulse width modulation signal, a reset end coupled to the output end of the first AND gate and an output end;
a second inverter, comprising an input end coupled to the output end of the third flip-flop and an output end;
a third inverter, comprising an input end coupled to the output end of the fourth flip-flop and an output end;
a first pre-driver, comprising an input end coupled to the output end of the second inverter, a first output end for outputting the first control signal and a second output end for outputting the third control signal; and
a second pre-driver, comprising an input end coupled to the output end of the third inverter, a first output end for outputting the second control signal and a second output end for outputting the fourth control signal; and
a compensation signal generating unit, comprising:
a third impulse generator, comprising an input end for receiving the pulse width modulation signal and an output end for outputting a third impulse signal;
a second AND gate, comprising a first input end for receiving the third impulse signal, a second input end for receiving the boost signal and an output end;
a fourth inverter, for outputting the inverted first control signal; and
an OR gate, comprising a first input end coupled to the output end of the second AND gate, a second input end coupled to the output end of the fourth inverter and an output end for outputting the slope compensation control signal.

18. A power converting device, comprising:
an inductor;
a first switch, coupled between an input end and a first end of the inductor for controlling the connection between the input end and the first end according to a first control signal;
a second switch, coupled between a second end of the inductor and ground for controlling the connection between the second end and ground according to a second control signal;
a third switch, coupled between the first end of the inductor and ground for controlling the connection between the first end and ground according to a third control signal;
a fourth switch, coupled between the second end of the inductor and an output end for controlling the connection between the second end and the output end according to a fourth control signal; and
a feedback control circuit, for outputting the first control signal, the second control signal, the third control signal and the fourth control signal according to an output voltage of the output end and a switch current of the first switch, to control conducting sequences of the first switch, the second switch, the third switch and the fourth switch.

19. The power converting device of claim 18, wherein the feedback control circuit comprises:
a pulse width modulation module, comprising:
a voltage dividing unit coupled to an output end for outputting a feedback voltage according to an output voltage of the power converting device;
an error amplifier, coupled to the voltage dividing unit for generating an error voltage according to the feedback voltage and a first reference voltage;
a current detecting unit, for detecting a switch current of the first switch;
a slope compensation unit, for generating a ramp voltage according to a slope compensation control signal;
an adding unit, coupled to the current detecting unit and the slope compensation unit for generating a second reference voltage according to the switch current and the ramp voltage; and
a comparing unit, coupled to the error amplifier and the adding unit for generating a pulse width modulation signal according to the error voltage and the second reference voltage signal;
a clock generating module, for generating a clock signal; and
a logic control module, for generating a first control signal, a second control signal, a third control signal, a fourth control signal, to separately control the first switch, the second switch, the third switch and the fourth switch and the slope compensation control signal according to the clock signal and the pulse width modulation signal.

20. The power converting device of claim 19, wherein the logic control module adjusts the slope compensation control signal for resetting the ramp voltage to the ground end when the first switch is disconnected.

21. The power converting device of claim 19, wherein while the first switch is conductive and the second switch and the fourth are alternately conductive, the logic control module adjusts the slope compensation control signal for resetting the ramp voltage to the ground voltage and increasing the ramp voltage in a constant slope when the pulse width modulation signal instructs the error voltage to be smaller than the second reference voltage.

22. The power converting device of claim 19, wherein when the first switch is conductive, the second switch is disconnected, the third switch is disconnected, the fourth switch is conductive, the clock signal instructs a clock period to begin and the pulse width modulation signal instructs the error voltage to be greater than the second reference voltage, and the logic control module then conducts the first switch and the second switch and disconnects the third switch and the fourth switch through the first control signal, the second control signal, the third control signal and the fourth control signal.

23. The power converting device of claim 19, wherein when the first switch is conductive, the second switch is disconnected, the third switch is disconnected, the fourth switch is conductive and the pulse width modulation signal instructs the error voltage to be smaller than the second reference voltage, and the logic control module then conducts the third switch and the fourth switch and disconnects the first switch and the second switch through the first control signal, the second control signal, the third control signal and the fourth control signal.

24. The power converting device of claim 19, wherein when the first switch is conductive, the second switch is conductive, the third switch is disconnected, the fourth switch is disconnected and the pulse width modulation signal instructs the error voltage to be smaller than the second reference voltage, and the logic control module then conducts the first switch and the fourth switch and disconnects the second switch and the third switch through the first control signal, the second control signal, the third control signal and the fourth control signal.

25. The power converting device of claim 19, wherein when the first switch is disconnected, the second switch is disconnected, the third switch is conductive, the fourth switch is conductive, the clock signal instructs a clock period to begin and the pulse width modulation signal instructs the error voltage to be greater than the second reference voltage, and the logic control module then conducts the first switch and the fourth switch and disconnects the second switch and the third switch through the first control signal, the second control signal, the third control signal and the fourth control signal.

26. The power converting device of claim 19, wherein the logic control module comprises:
a control signal generating unit, comprising:
a first inverter, for outputting an inverted second control signal;
a first flip-flop, comprising a data end for receiving the inverted second control signal, a clock end for receiving the pulse width modulation signal, a reset end for receiving a first impulse signal and an output end for outputting a buck signal;
a second flip-flop, comprising a data end for receiving the first control signal, a clock end for receiving the clock signal, a reset end for receiving a second impulse signal and an output end for outputting a boost signal;
a first impulse generator, comprising an input end for receiving the boost signal and an output end for outputting the first impulse signal;
a second impulse generator, comprising an input end for receiving the buck signal and an output end for outputting the second impulse signal;
a first AND gate, comprising a first input end for receiving the buck signal, a second input end for receiving the pulse width modulation signal and an output end;
a second AND gate, comprising a first input end for receiving the boost signal, a second input end for receiving the clock signal and an output end;
a third flip-flop, comprising a reset end coupled to the output end of the first AND gate, a set end for receiving the clock signal and an output end;
a fourth flip-flop, comprising a reset end for receiving the pulse width modulation signal, a reset end coupled to the output end of the second AND gate and an output end;
a first pre-driver, comprising an input end coupled to the output end of the third flip-flop, a first output end for outputting the first control signal and a second output end for outputting the third control signal; and
a second pre-driver, comprising an input end coupled to the output end of the fourth flip-flop, a first output end for outputting the second control signal and a second output end for outputting the fourth control signal; and
a compensation signal generating unit, comprising:
a third impulse generator, comprising an input end for receiving the pulse width modulation signal and an output end for outputting a third impulse signal;
a third AND gate, comprising a first input end for receiving the third impulse signal, a second input end for receiving the boost signal and an output end;
a second inverter, for outputting the inverted first control signal; and
an OR gate, comprising a first input end coupled to the output end of the third AND gate, a second input end coupled to the output end of the second inverter and an output end for outputting the slope compensation control signal.

27. The power converting device of claim 19, wherein the control signal generating unit, comprising:
a first inverter, for outputting an inverted second control signal;
a first flip-flop, comprising a data end for receiving the inverted second control signal, a clock end for receiving the pulse width modulation signal, a reset end for receiving a first impulse signal and an output end for outputting a buck signal;
a second flip-flop, comprising a data end for receiving the first control signal, a clock end for receiving the clock signal, a reset end for receiving a second impulse signal and an output end for outputting a boost signal;
a first impulse generator, comprising an input end for receiving the boost signal and an output end for outputting the first impulse signal;
a second impulse generator, comprising an input end for receiving the buck signal and an output end for outputting the second impulse signal;
a first AND gate, comprising a first input end for receiving the boost signal, a second input end for receiving the clock signal and an output end;
a third flip-flop, comprising a data end for receiving a system maximum voltage, a clock end for receiving the pulse width modulation signal, a reset end for receiving the clock signal and an output end;
a fourth flip-flop, comprising a data end for receiving the buck signal, a clock end for receiving the pulse width modulation signal, a reset end coupled to the output end of the first AND gate and an output end;
a second inverter, comprising an input end coupled to the output end of the third flip-flop and an output end;
a third inverter, comprising an input end coupled to the output end of the fourth flip-flop and an output end;
a first pre-driver, comprising an input end coupled to the output end of the second inverter, a first output end for outputting the first control signal and a second output end for outputting the third control signal; and
a second pre-driver, comprising an input end coupled to the output end of the third inverter, a first output end for outputting the second control signal and a second output end for outputting the fourth control signal; and
a compensation signal generating unit, comprising:
a third impulse generator, comprising an input end for receiving the pulse width modulation signal and an output end for outputting a third impulse signal;
a second AND gate, comprising a first input end for receiving the third impulse signal, a second input end for receiving the boost signal and an output end;
a fourth inverter, for outputting the inverted first control signal; and
an OR gate, comprising a first input end coupled to the output end of the second AND gate, a second input end coupled to the output end of the fourth inverter and an output end for outputting the slope compensation control signal.
